(19) United States
(12) Patent Application Publication
(10) Pub. No.: US 2018/0365492 A1
(43) Pub. Date: Dec. 20, 2018

(54) METHODS AND SYSTEMS FOR WEARABLE COMPUTING DEVICE

(71) Applicant: Mesa Digital, LLC, Albuquerque, NM (US)

(72) Inventors: Luis M. Ortiz, Albuquerque, NM (US); Kermit D. Lopez, Albuquerque, NM (US)

(73) Assignee: Mesa Digital, LLC, Albuquerque, NM (US)

(21) Appl. No.: 15/921,111

(22) Filed: Mar. 14, 2018

Related U.S. Application Data
(63) Continuation of application No. 14/799,758, filed on Jul. 15, 2015, now abandoned.
(60) Provisional application No. 62/024,734, filed on Jul. 15, 2014.

(51) Int. Cl. G06K 9/00; G02B 27/01

(52) U.S. Cl. CPC G06K 9/00617; G06K 9/00885; G02B 2027/0178; G02B 2027/014; G02B 27/017

(57) ABSTRACT

A wearable device that can provide images via a display located within two inches and in view of a human eye in association with headgear, and can biometrically authenticate an authorized user based on at least one of a user's eye. The wearable device can access a data network and determine a user's location. An authorized user can be provided with data based on the user's identity and location as determined by a wearable device. The location of a user within a venue can be determined using radio frequency transponders in communication with a wearable device and authenticating the user via biometric attributes of a user's eye as captured by a imaging device associated with the wearable device. Sensitive data can be managed in association with a patient based on health provider authentication and identity of a transponder used in association with the patient.

### CROSS-REFERENCE TO PROVISIONAL APPLICATION

This patent application is a continuation of U.S. patent application Ser. No. 14/799,758, entitled “METHODS AND SYSTEMS FOR WEARABLE COMPUTING DEVICE,” filed on Jul. 15, 2015, which claims the benefit under 35 U.S.C. § 119(e) of U.S. Provisional Application Ser. No. 62/024,734, entitled “METHODS AND SYSTEMS FOR WEARABLE COMPUTING DEVICE,” which was filed on Jul. 15, 2014, and both applications are incorporated herein by reference in their entirety.

### FIELD OF THE INVENTION

Embodiments are generally related to wearable computing devices, such as, for example, digital glasses, virtual reality goggles, electro-optical systems used in association with eyewear. Embodiments are additionally related to the field of wireless communications including the use of venue-based transponders and user authentication.

### BACKGROUND

Wearable computing devices (“wearable devices”) come in a variety of implementations and configurations. For example, some wearable computing devices are implemented in the context of wristwatch type devices and others are configured in the context of optical head-mounted display (OHMD) devices (e.g., head gear), such as, for example, a head wearable device implemented in the context of eyeglasses or gaming goggles. Such OHMD or head gear devices display information for a wearer in a smartphone-like hands free format capable of communication with the Internet via, for example, natural language voice commands.

One of the main features of a wearable computer is consistency. There is a constant interaction between the computer and user, i.e. there is no need to turn the device on or off. Another feature is the ability to multi-task. It is not necessary to stop what you are doing to use the device; it is augmented into all other actions. These devices can be incorporated by the user to act like a prosthetic. It can therefore be an extension of the user's mind and/or body.

In some implementations of an OHMD device, a touchpad may be located on the side of the device, allowing a user to control the device by swiping through a timeline-like interface displayed on the screen. Sliding backward can show, for example, current events, such as weather, and sliding forward, for example, can show past events, such as phone calls, photos, updates, etc.

Some implementations of an OHMD may also include the ability to capture images (e.g., take photos and record video). While video is recording, the display screen may stay on. Additionally, the OHMD device may include a Liquid Crystal on Silicon (LCoS), field-sequential color, LED illuminated display. The display's LED illumination is first P-polarized and then shines through the in-coupling polarizing beam splitter (PBS) to the LCoS panel. The panel reflects the light and alters it to S-polarization at active pixel sites. The in-coupling PBS then reflects the S-polarized areas of light at 45° through the out-coupling beam splitter to a collimating reflector at the other end. Finally, the out-coupling beam splitter reflects the collimated light another 45° and into the wearer's eye.

One example of a wearable device is the Google Glass device, which is a wearable device with an optical head-mounted display (OHMD). It was developed by Google with the mission of producing a mass-market ubiquitous computer. Google Glass displays information in a smartphone-like hands-free format. Wearers communicate with the Internet via natural language voice commands. Another example of a wearable device is Samsung's “Gear Blink” wearable device, which is similar to Google Glass. Yet another example of a wearable device is the “Oculus Rift™” virtual reality headset for 3D gaming released by Oculus VR in 2013.

### SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for a wearable device that can provide images via a display located within two inches and in view of a human eye in association with headgear, and can biometrically authenticate an authorized user based on biometrics including an image captured by a camera associated with the headgear of at least one of a user's eyes, wherein the camera faces inward toward at least one of a user's eyes.

It is another aspect of the disclosed embodiments to provide for a wearable device that can access a data network and determine a user's location.

It is yet another aspect of the disclosed embodiments to provide an authorized user with data based on the user's identity and location as determined by a wearable device.

It still another aspect of the disclosed embodiments to provide for a method of determining the location of a user within a venue using radio frequency transponders in communication with a wearable device and authenticating the user via biometric attributes of a user's eye as captured by a imaging device associated with the wearable device.

It is also an aspect of the disclosed embodiments to provide security over data communicated with a wearable device.

The aforementioned aspects and other objectives and advantages can now be achieved as described herein. Methods and systems are disclosed for providing data and/or services to wearable devices. A user of a wearable device can be authenticated via at least one biometric associated with the user and via a biometric scanner associated with the wearable device. Data and/or services can be displayed and/or provided via a user interface of the wearable device, in response to authenticating the user via the biometric scanner. Authentication of the user can involve determining the identity of the user and providing the user access to the data and/or the services based on at least one of the identity of the user and access level of the user.

The biometric scanner can be integrated with an optical and/or image-processing system associated with the wearable device. The wearable device can be implemented as, for example, head gear. Such head gear can be, for example, eyeglasses (e.g., data enabled eyewear) or a hardware system configured in the form of virtual reality gaming goggles worn by the user. The at least one biometric can be, for example, an iris scan gathered through optics integrated with the wearable device. In some cases, the at least one biometric can be, for example, at least one other biometric gathered through the wearable device. Authentication can be facilitated by, for example, a remote server. The data and/or the services accessed based on the identity of the user can be retrieved from a remote server.

In one embodiment, the wearable device can be associated with a wireless hand held communications device. The data and/or the services can be wirelessly communicated between the wearable device and the wireless hand held communications device (e.g., via Bluetooth communications). The wireless hand held communications device can be authenticated based on, for example, the at least one biometric. Additionally, data and/or services can be wirelessly communicated between the wearable device and at least one transponder out of a plurality of transponders dispersed throughout a venue. In general, the at least one transponder may be within at least a Bluetooth range or a WiFi range of communication of the wearable device.

The location of the wearable device can be determined via the at least one transponder and also based on the physical proximity of the wearable device to the at least one transponder. Data can be wirelessly delivered and/or wirelessly provided to the wearable device with respect to the at least one transponder based on authenticating the user via the at least one biometric via the wearable device. The data can be, for example, advertising information, statistics, historical information associated with at least one of a tour, museum, monument, famous person and municipality or other types of data.

In an embodiment, such data may be medical data. In this case, the user can be authenticated as a medical provider authorized to receive the medical data based on a location of the user near the at least one transponder located in association with a patient for which the medical data is provided. The wearable device can enable the medical provider to record a medical procedure as video via a camera integrated with the wearable device and also create medical annotations while treating the patient. Such annotations may be, for example, voice annotations recorded by a microphone associated with the wearable device. The annotations and the video can be securely stored on a server as a medical record in association with the patient and is only available for subsequent retrieval by authorized medical providers. Although GPS could determine user location, a transponder located in association with a patient to determine location of the medical provider assures that accurate access and data association is maintained should a patient be moved around.

In another embodiment, the user may be authenticated as a field technician and the data may be data in support of addressing a field problem and the data is displayable for the technician via the wearable device. In yet another embodiment, the user can be authenticated as a legal professional and the data can be legal information in support of accomplishing litigation. In still another embodiment, the user may be authenticated as a clerk in a retail establishment and the data may be merchandise information. In some embodiments, the data may be a coupon or a group of coupons (i.e., digital coupons).

In another embodiment, a user profile can be established with respect to the user and the at least one biometric for use in the authenticating of the user and establishing an access level with respect to the user for access to the data and/or the services. In still another embodiment, the venue may be a sports venue and/or an entertainment venue and the user comprises a spectator at the sports venue and/or the entertainment venue. In another embodiment, a step or logical operation may be provided for invoking via the user interface of the wearable device, a user interactivity with respect to the data, and/or the services via the wearable device.

In another embodiment, a system for providing data and/or services to wearable devices can be provided. Such a system can include, for example, a wearable device associated with a biometric scanner wherein a user of said wearable device is authenticated via at least one biometric associated with said user and via said biometric scanner associated with said wearable device. Such a system can further include a user interface that enables interaction of a user with said wearable device. Such a system can further include an image display area enabling viewing of data by a user, wherein data and/or services are displayable via said image display area associated with said wearable device, in response to authenticating said user via said biometric scanner. Such a biometric scanner can be, for example, a retinal scanner, an iris recognition scanner, a voice recognition scanner, a fingerprint recognition device, or, for example, an ear acoustical scanner for biometric identification using acoustic properties of an ear canal.

A wireless communications module can be integrated in or associated with the wearable device to enable communications with networks and transponders as needed to access data and manage data. The wearable device can also be capable of bi-directional communication with a second screen in order to provide a larger viewing platform for at least one of said data and/or said services, complimentary data and/or services, common data and/or services in support of a multiplayer gaming scenario, and particular data selected for rendering aside from data viewed on said wearable device. The second screen is a display screen located within viewing proximity of said wearable device. Second screens can include a display screen associated or integrated with: a smartphone, a laptop computer, a tablet computing device, a flat panel television, an automotive dashboard, a projector, and an airliner seat.

Services are capable of being wirelessly communicated between a wearable device and at least one transponder out of a plurality of transponders and dispersed throughout a venue. The at least one transponder can be within at least a Bluetooth range or a WiFi range of communication with said wearable device. The location of a wearable device can be determined via said at least one transponder and based on a proximity of said wearable device to said at least one transponder.

Safety services can also be provided in association with a wearable device and described herein. The wearable device can include a user interface, at least one motion sensor, and image capturing optics in association with at least one eye location. The motion sensor and image capturing optics can monitor and process head and eye movement activity to assess driver fatigue. An image display area associated with said at least one eye location can also enable the viewing of navigational data by a user. An alarm can alert a user when fatigue is detected. Access to a wireless data network can enable remote monitoring of a user by a central station in addition to providing navigation information.

A wearable device in the form of eyeglasses can include at least one LED light integrated within a frame of said eyeglasses that is responsive to a user interface. The user interface can be manipulated by a user to turn the at least one LED light on to illuminate an area located in front of the eyeglasses and said user. A digital camera integrated within said frame, said digital camera capturing images located in front of said eyeglasses and said user, an image display area associated with said at least one eye location enabling viewing of data by a user.

### BRIEF DESCRIPTION OF THE FIGURES

The accompanying figures, in which like reference numerals refer to identical or functionally-similar elements throughout the separate views and which are incorporated in and form a part of the specification, further illustrate the present invention and, together with the detailed description herein, serve to explain the principles of the disclosed embodiments.

FIG. 1 illustrates an exemplary system for receiving, transmitting, and displaying data;

FIG. 2 shows an alternate view of the system of FIG. 1;

FIG. 3A shows an example system for receiving, transmitting, and displaying data;

FIG. 3B shows an example system for receiving, transmitting, and displaying data;

FIG. 4 shows an example system for receiving, transmitting, and displaying data;

FIGS. 5A and 5B show a wearable computer device according to an embodiment;

FIG. 6 shows a front elevation view of the device of FIG. 5;

FIG. 7 shows the device of FIG. 5 in an adjusted configuration thereof;

FIG. 8 shows the device of FIG. 5 in various stages of adjustment of a portion thereof;

FIG. 9 shows the device of FIG. 5 during various stages of adjustment of another portion thereof;

FIG. 10 shows an exploded view of the device of FIG. 5 according to a modular configuration thereof;

FIG. 11 shows a portion of the device of FIG. 5;

FIG. 12 illustrates a high-flow chart of operations depicting logical operational steps of a method for providing data and/or services to a wearable device, in accordance with a preferred embodiment;

FIG. 13 illustrates a high-flow chart of operations depicting logical operational steps of a method for providing data and/or services to a wearable device, in accordance an alternative embodiment;

FIG. 14 illustrates a high-flow chart of operations depicting logical operational steps of a method for providing data and/or services to a wearable device, in accordance an alternative embodiment;

FIG. 15 illustrates a high-flow chart of operations depicting logical operational steps of a method for providing data and/or services to a wearable device, in accordance an alternative embodiment;

FIG. 16 illustrates a block diagram depicting other potential user applications for wearable devices, in accordance with alternative embodiments;

FIG. 17 illustrates a block diagram of a system for providing data and/or services to wearable devices, in accordance with an alternative embodiment;

FIG. 18 illustrates a block diagram of a system for providing data and/or services to wearable device, in accordance with an alternative embodiment;

FIG. 19 illustrates a block diagram of a system for providing data and/or services to wearable device, in accordance with an alternative embodiment;

FIG. 20 illustrates a block diagram of a system for providing data and/or services to a wearable device that can communicate with a plurality of transponders, in accordance with an alternative embodiment; and

FIG. 21 illustrates a block diagram of a system for providing data and/or services to a wearable device in accordance with an alternative embodiment.

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the disclosed embodiments. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which disclosed embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one skilled in the art, the present invention can be embodied as a method, system, and/or a processor-readable medium. Accordingly, the embodiments may take the form of an entire hardware application, an entire software embodiment or an embodiment combining software and hardware aspects all generally referred to herein as a “circuit” or “module.” Furthermore, the embodiments may take the form of a computer program product on a computer-usable storage medium having computer-usable program code embodied in the medium. Any suitable computer readable medium may be utilized including, for example, hard disks, USB Flash Drives, DVDs, CD-ROMs, optical storage devices, magnetic storage devices, etc.

Computer program code for carrying out operations of the disclosed embodiments may be written in an object oriented programming language (e.g., Python, Java, PHP C++, etc.). The computer program code, however, for carrying out operations of the disclosed embodiments may also be written in conventional procedural programming languages, such as the “C” programming language or in a visually oriented programming environment, such as, for example, Visual Basic.

The program code may execute entirely on the users computer, partly on the user's computer, as a stand-alone software package, partly on the user's computer and partly on a remote computer or entirely on the remote computer. In the latter scenario, the remote computer may be connected to a user's computer through a local area network (LAN) or a wide area network (WAN), wireless data network e.g., WiFi, Wimax, 802.xx, and cellular network or the connection may be made to an external computer via most third party supported networks (for example, through the Internet using an Internet Service Provider).

Aspects of the disclosed embodiments can be implemented as an “app” or application software that runs in, for example, a web browser and/or is created in a browser-supported programming language (e.g., such as a combination of JavaScript, HTML, and CSS) and relies on a web browser to render the application. The ability to update and maintain web applications without distributing and installing software on potentially thousands of client computers is a key reason for the popularity of such apps, as is the inherent support for cross-platform compatibility. Common web applications include webmail, online retail sales, online auctions, wikis, and many other functions. Such an “app” can also be implemented as an Internet application that runs on smartphones, tablet computers, wearable devices, and other computing devices such as laptop and personal computers.

The disclosed embodiments are described in part below with reference to flowchart illustrations and/or block diagrams of methods, systems, computer program products, and data structures according to preferred and alternative embodiments. It will be understood that each block of the illustrations, and combinations of blocks, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

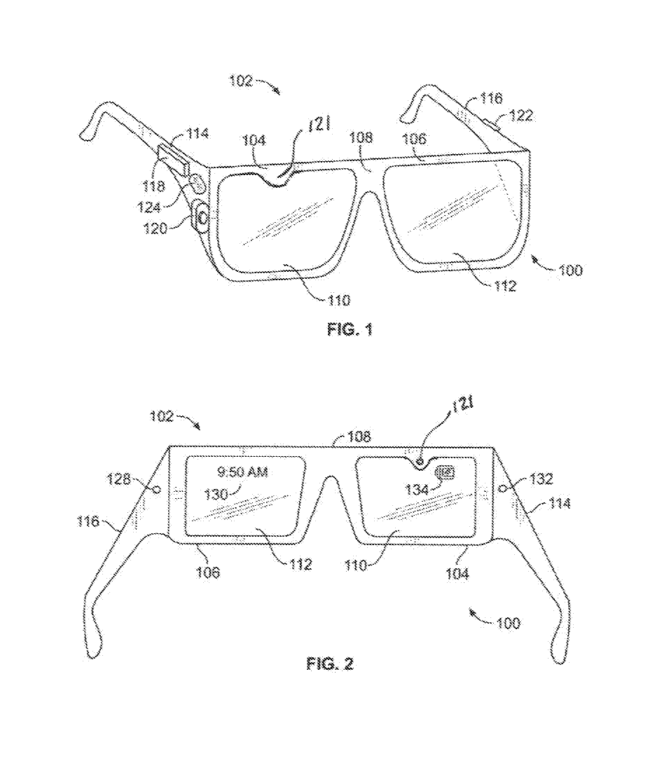

Embodiments of the present disclosure are described herein with reference to the drawing figures. FIG. 1 illustrates a system 100 for receiving, transmitting, and displaying data. The system 100 is shown in the form of a wearable computing device (i.e., a wearable device). While FIG. 1 illustrates a head-mounted device 102 as an example of a wearable computing device, other types of wearable devices can be additionally or alternatively used. As illustrated in FIG. 1, the head-mounted device 102 comprises frame elements including lens-frames 104, 106 and a center frame support 108, lens elements 110, 112, and extending side-arms 114, 116. The center frame support 108 and the extending side-arms 114, 116 are configured to secure the head-mounted device 102 to a user's face via a user's nose and ears, respectively.

Each of the frame elements 104, 106, and 108 and the extending side-arms 114, 116 may be formed of a solid structure of plastic and/or metal, or may be formed of a hollow structure of similar material so as to allow wiring and component interconnects to be internally routed through the head-mounted device 102. Other materials may be possible as well.

One or more of each of the lens elements 110, 112 may be formed of any material that can suitably display a projected image or graphic. Each of the lens elements 110, 112 may also be sufficiently transparent to allow a user to see through the lens element. Combining these two features of the lens elements may facilitate an augmented reality or heads-up display where the projected image or graphic is superimposed over a real-world view as perceived by the user through the lens elements.

The extending side-arms 114, 116 may each be projections that extend away from the lens-frames 104, 106, respectively, and may be positioned behind a user's ears to secure the head-mounted device 102 to the user. The extending side-arms 114, 116 may further secure the head-mounted device 102 to the user by extending around a rear portion of the user's head. Additionally or alternatively, for example, the system 100 may connect to or be affixed within a head-mounted helmet structure. Other possibilities exist as well.

The system 100 may also include an on-board computing system 118, a first video camera 120 capturing images from a user's point of view (e.g., images in front of the user), a second video camera 121 facing inward towards a user's eye to capture images of the user's eye (for user monitoring and biometric capture), a sensor 122, and a finger-operable touch pad 124. The on-board computing system 118 is shown to be positioned on the extending side-arm 114 of the head-mounted device 102; however, the on-board computing system 118 may be provided on other parts of the head-mounted device 102 or may be positioned remote from the head-mounted device 102 (e.g., the on-board computing system 118 could be wire- or wirelessly-connected to the head-mounted device 102). The on-board computing system 118 may include a processor and memory, for example. The on-board computing system 118 may be configured to receive and analyze data from the video cameras 120/121 and the finger-operable touch pad 124 (and possibly from other sensory devices, user interfaces, or both) and generate images for output by the lens elements 110 and 112.

The first video camera 120 is shown positioned on the extending side-arm 114 of the head-mounted device 102; however, the first video camera 120 may be provided on other parts of the head-mounted device 102. The first video camera 120 may be configured to capture images at various resolutions or at different frame rates. Many video cameras with a small form-factor, such as those used in cell phones or webcams, for example, may be incorporated into an example of the system 100.

Further, although FIG. 1 illustrates one forward facing video camera 120, more video cameras may be used, and each may be configured to capture the same view, or to capture different views. For example, a first video camera 120 may be forward facing to capture at least a portion of the real-world view perceived by the user. This forward facing image captured by the first video camera 120 may then be used to generate an augmented reality where computer generated images appear to interact with the real-world view perceived by the user. The second video camera 121 should be located in a position around either lens area facing inward towards a user's eye in order to provide the best vantage point to capture biometric information (e.g., iris scan) and to monitor the user (e.g., to monitor eye blink or eyeball movement indicative of driver fatigue).

The sensor 122 is shown on the extending side-arm 116 of the head-mounted device 102; however, the sensor 122 may be positioned on other parts of the head-mounted device 102. The sensor 122 may include one or more of a gyroscope or an accelerometer, for example. Other sensing devices may be included within, or in addition to, the sensor 122 or other sensing functions may be performed by the sensor 122.

The finger-operable touch pad 124 is shown on the extending side-arm 114 of the head-mounted device 102. However, the finger-operable touch pad 124 may be positioned on other parts of the head-mounted device 102. Also, more than one finger-operable touch pad may be present on the head-mounted device 102. The finger-operable touch pad 124 may be used by a user to input commands. The finger-operable touch pad 124 may sense at least one of a position and a movement of a finger via capacitive sensing, resistance sensing, or a surface acoustic wave process, among other possibilities. The finger-operable touch pad 124 may be capable of sensing finger movement in a direction parallel or planar to the pad surface, in a direction normal to the pad surface, or both, and may also be capable of sensing a level of pressure applied to the pad surface.

The finger-operable touch pad 124 may be formed of one or more translucent or transparent insulating layers and one or more translucent or transparent conducting layers. Edges of the finger-operable touch pad 124 may be formed to have a raised, indented, or roughened surface, so as to provide tactile feedback to a user when the user's finger reaches the edge, or other area, of the finger-operable touch pad 124. If more than one finger-operable touch pad is present, each finger-operable touch pad may be operated independently, and may provide a different function.

FIG. 2 illustrates an alternate view of the system 100 illustrated in FIG. 1. As shown in FIG. 2, the lens elements 110, 112 may act as display elements. The head-mounted device 102 may include a first projector 128 coupled to an inside surface of the extending side-arm 116 and configured to project a display 130 onto an inside surface of the lens element 112. Additionally or alternatively, a second projector 132 may be coupled to an inside surface of the extending side-arm 114 and configured to project a display 134 onto an inside surface of the lens element 110.

The lens elements 110, 112 may act as a combiner in a light projection system and may include a coating that reflects the light projected onto them from the projectors 128, 132. In some embodiments, a reflective coating may not be used (e.g., when the projectors 128, 132 are scanning laser devices).

In alternative embodiments, other types of display elements may also be used. For example, the lens elements 110, 112 themselves may include: a transparent or semi-transparent matrix display, such as an electroluminescent display or a liquid crystal display, one or more waveguides for delivering an image to the user's eyes, or other optical elements capable of delivering an in focus near-to-eye image to the user. A corresponding display driver may be disposed within the frame elements 104, 106 for driving such a matrix display. Alternatively or additionally, a laser or LED source and scanning system could be used to draw a raster display directly onto the retina of one or more of the user's eyes. Other possibilities exist as well.

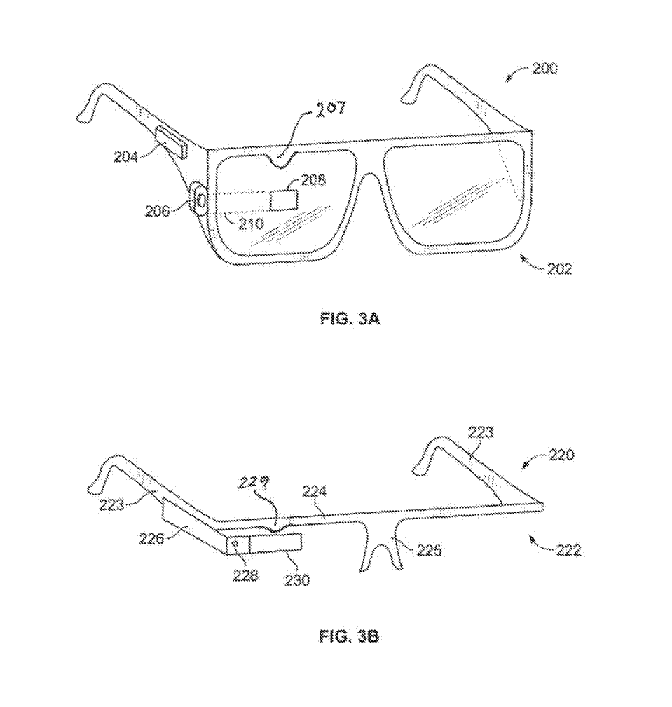

FIG. 3A illustrates an example system 200 for receiving, transmitting, and displaying data. The system 200 is shown in the form of a wearable computing device 202. The wearable computing device 202 may include frame elements and side-arms such as those described with respect to FIGS. 1 and 2. The wearable computing device 202 may additionally include an on-board computing system 204 and a first video camera 206, and a second video camera 207, such as those described with respect to FIGS. 1 and 2. The video camera 206 is shown mounted on a frame of the wearable computing device 202; however, the first video camera 206 may be mounted at other positions as well, but the second video camera should be positioned to capture images of the user's eye.

As shown in FIG. 3A, the wearable computing device 202 may include a single display 208 which may be coupled to the device. The display 208 may be formed on one of the lens elements of the wearable computing device 202, such as a lens element described with respect to FIGS. 1 and 2, and may be configured to overlay computer-generated graphics in the user's view of the physical world. The display 208 is shown to be provided in a center of a lens of the wearable computing device 202, however, the display 208 may be provided in other positions. The display 208 is controllable via the computing system 204 that is coupled to the display 208 via an optical waveguide 210.

FIG. 3B illustrates an example system 220 for receiving, transmitting, and displaying data. The system 220 is shown in the form of a wearable computing device 222. The wearable computing device 222 may include side-arms 223, a center frame support 224, and a bridge portion with nosepiece 225. In the example shown in FIG. 3B, the center frame support 224 connects the side-arms 223. The illustrated wearable computing device 222 does not include lens-frames containing lens elements. The wearable computing device 222 may additionally include an onboard computing system 226, a first video camera 228, and a second video camera 229, such as those described with respect to FIGS. 1 and 2.

The wearable computing device 222 may include a single lens element 230 that may be coupled to one of the side-arms 223 or the center frame support 224. The lens element 230 may include a display such as the display described with reference to FIGS. 1 and 2, and may be configured to overlay computer-generated graphics upon the user's view of the physical world. In one example, the single lens element 230 may be coupled to the inner side (i.e., the side exposed to a portion of a user's head when worn by the user) of the extending side-arm 223. The single lens element 230 may be positioned in front of or proximate to a user's eye when the wearable computing device 222 is worn by a user. For example, the single lens element 230 may be positioned below the center frame support 224, as shown in FIG. 3B.

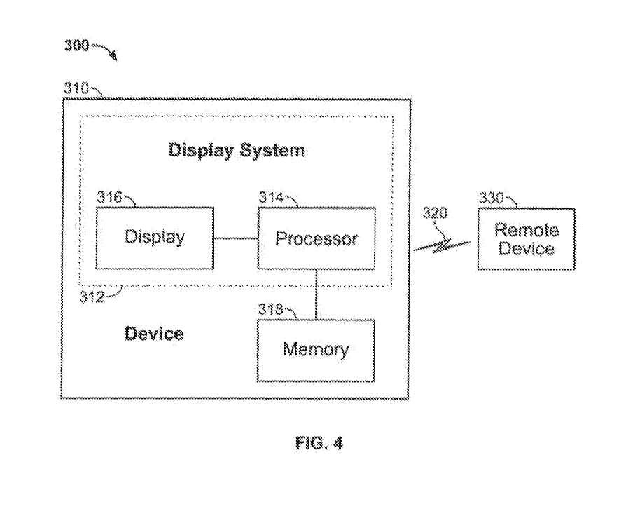

FIG. 4 illustrates a schematic drawing of an example computer network infrastructure. In system 300, a device 310 communicates using a communication link 320 (e.g., a wired or wireless connection) to a remote device 330. The device 310 may be any type of device that can receive data and display information corresponding to or associated with the data. For example, the device 310 may be a heads-up display system, such as the head-mounted device 102, 200, or 220 described with reference to FIGS. 1-38.

Thus, the device 310 may include a display system 312 comprising a processor 314 and a display 316. The display 310 may be, for example, an optical see-through display, an optical see-around display, or a video see-through display. The processor 314 may receive data from the remote device 330, and configure the data for display on the display 316. The processor 314 may be any type of processor, such as a micro-processor or a digital signal processor, for example.

The device 310 may further include on-board data storage, such as memory 318 coupled to the processor 314. The memory 318 may store software that can be accessed and executed by the processor 314, for example.

The remote device 330 may be any type of computing device or transmitter including a laptop computer, a mobile telephone, or tablet computing device, etc., that is configured to transmit data to the device 310. The remote device 330 and the device 310 may contain hardware to enable the communication link 320, such as processors, transmitters, receivers, antennas, etc.

In FIG. 4, the communication link 320 is illustrated as a wireless connection; however, wired connections can also be used. For example, the communication link 320 may be a wired serial bus such as a universal serial bus or a parallel bus. A wired connection may be a proprietary connection as well. The communication link 320 can also be a wireless connection using, e.g., Bluetooth™ radio technology, communication protocols described in IEEE 802.xx (including any IEEE 802.11 revisions), Cellular technology (such as GSM, CDMA, UMTS, EVDO, WiMAX, or LTE), or Zigbee™ technology, among other possibilities. The remote device 330 can be accessible via the Internet and may include an accompanying smartphone handheld device, a tablet computer, and a computing cluster associated with a particular web service (e.g., social-networking, photo sharing, address book, etc.).

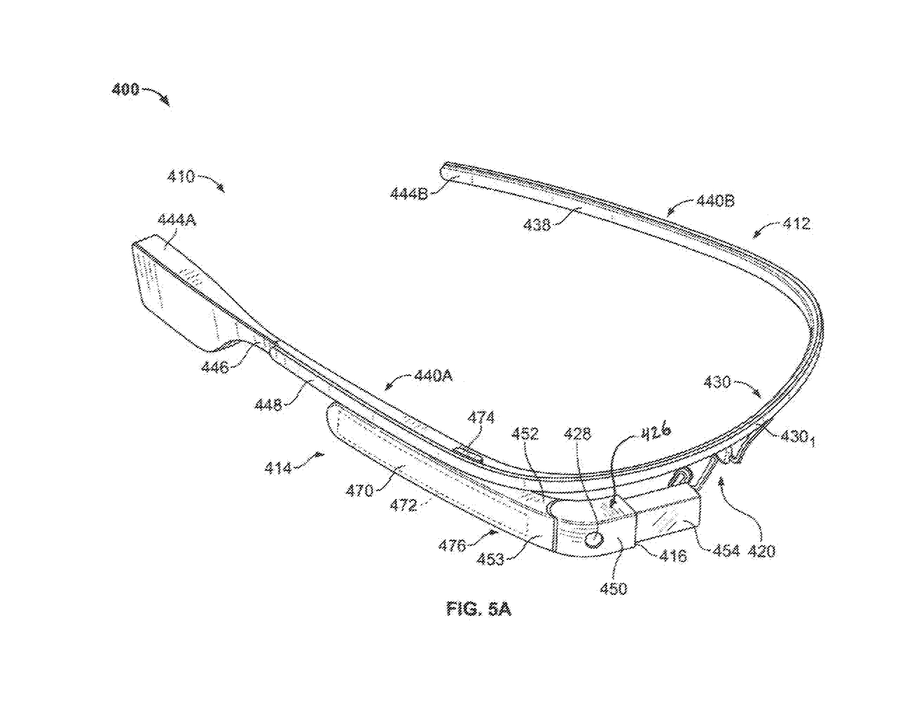

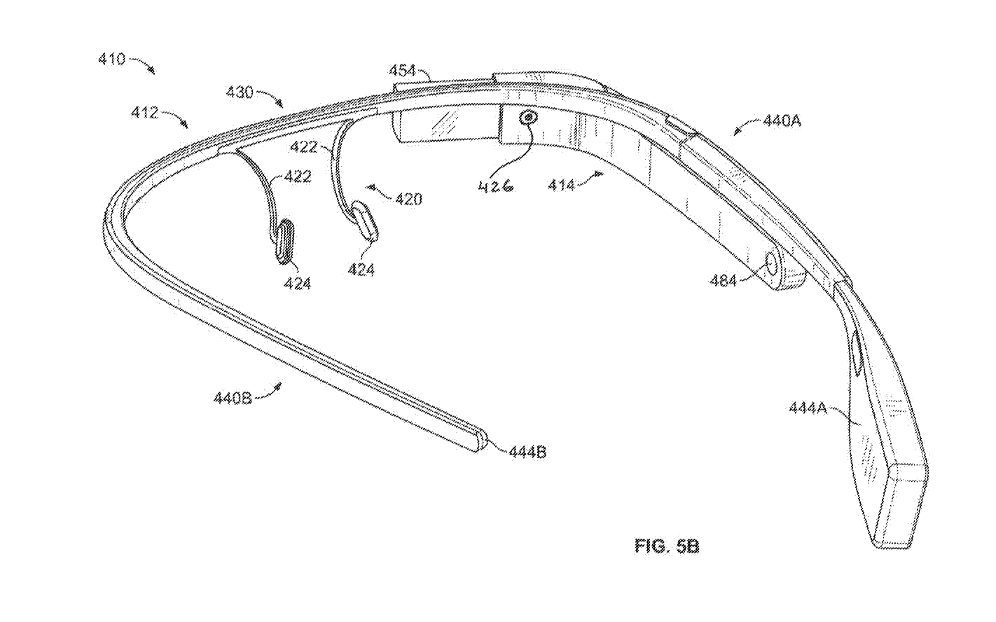

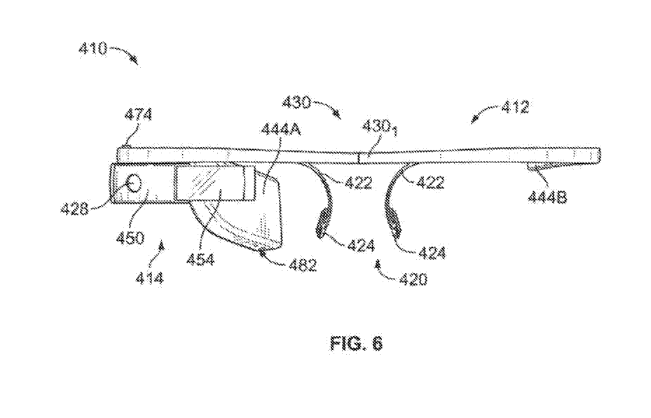

FIGS. 5A, 5B, and 6 illustrate an example system 400 for receiving, transmitting, and displaying data according to aspects of the disclosure. The system 400 is a wearable computing device and includes many of the same components included in the configurations described above. The device 410 shown in FIG. 5 is configured to be wearable on the head of the user. As will be described in greater detail below, device 410 includes a band 412 that provides a desired fit of device 410 on a user's head. Device 410 further includes an extension arm 414 that extends from a portion of band 412 to a display end 416 thereof that includes a display element 454. Extension arm 414 is configured such that, when device 410 is worn by a user, display 454 mounted on extension arm 414 can be positioned adjacent the user's eye, within the user's line of sight of at least that eye, for making an image presented thereon viewable by the user. In this manner, the extension arm 414 is configured to carry out at least one operation of the device 410, namely presenting an image to the user. Additional operations can also be carried out through extension arm 414, which can also include an input device in the form of a touch-based input 470 that is accessible to the user to execute a touch input gesture to execute a control function of the device assembly 410 or a function of another electronic device that is connected or in communication with device assembly 410.

Band 412 is shown in FIG. 5 as including a central portion 430 with side arms 440A, 440B extending away from opposite sides of the central portion 430. Central portion 430 includes nosepiece 420 configured to rest on the nose of a wearer with the central portion 430 providing a central support for side arms 440A, 440B, which can extend unitarily therefrom, or can at least appear to extend unitarily therefrom, with an area of transition between the central portion 430 and the side arms 440A, 440B including a bend or curve therebetween. Nose bridge 420 can include a pair of bridge arms 422 that extend from the central portion 430. In the view of the embodiment of device assembly 410 shown in FIGS. 5B and 6, bridge arms 422 extend in a downward direction from central portion 430. As in other figures, the orientation of device assembly 410 shown in FIG. 5 generally corresponds to the orientation of device 410 when being worn by a user when the user's head is in a neutral, upright position. The description of bridge arms 422 extending downward from central portion 430 is made in such a reference frame and is done for purposes of the present description. Discussion of any other relative reference directions is also made for similar purposes and none are intended to be limiting with respect to the present disclosure, unless explicitly stated.

Bridge arms 422 can include respective pads 424 thereon, which can be positioned to rest on parts of the nose of the wearer. Pads 424 can be made of a material that is softer than arms 422 for purposes of comfort. Additionally, the material that pads 424 are made from can be flexible or have a texture that prevents slippage along the surface of the user's nose. Bridge arms 422 can be flexible to further provide a comfortable fit and or grip on the user's nose. Further, bridge arms 422 can be bendable and repositionable so that the position of pads 424 can be changed to best fit the user. This can include movement closer together or farther apart or fore and aft relative to central portion 430, which can adjust the height of central portion 430 and, accordingly, the position of extension arm 414 and its display 454 relative to the user's eye.

Further adjustment of display and other structures thereof can be similar to those in the embodiments described above, as can the structures used to affix extension arm 414 to band 412. In other embodiments, structures similar to arms and pads can be integrally formed with central portion 430 and can be structured such that larger or smaller areas of the nose bridge 420 contact the nose of the user, compared to the embodiment shown. Accordingly, device 410 can be worn on a user's head such that nosepiece 420 can rest on the user's nose with side arms 440A, 440B extending over respective temples of the user and over adjacent ears. The device 420 can be configured, such as by adjustment of bridge arms 422 or other adjustments discussed below, such that display element 454 is appropriately positioned in view of one of the user's eyes. In one position, device 410 can be positioned on the user's head, with bridge arms 422 being adjusted to position display 454 in a location within the user's field of view, but such that the user must direct her eyes upward to fully view the image on the display.

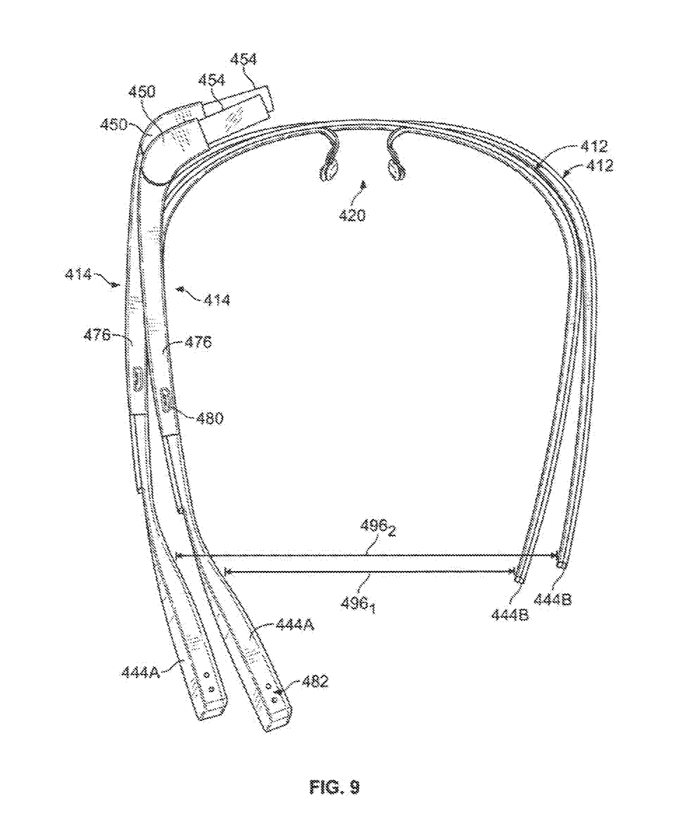

Side arms 440A, 440B can be configured to contact the head of the user along respective temples or in the area of respective ears of the user. Side arms 440A, 440B include respective free ends 444A, 444B opposite central portion 430. Free ends 444A, 444B can be positioned to be located near the ear of a user when wearing device 410. As shown in FIGS. 5 and 9, the center portion 430 and side arms 440A, 440B may generally have a “U” shape. In this example, the U shape is asymmetric. The asymmetry is due, in part, to the different configurations of the free ends 444A, 444B of the side arms 440A, 440B. As shown, free end 444A may be enlarged to house circuitry and/or a power supply (e.g., removable or rechargeable battery) for the system 400. The configurations of the two free ends may be switched so that free end 4448 houses circuitry and/or power supply equipment.

Enlarged free end 444A can be configured and positioned to provide a balancing weight to that of extension arm 414. Extension arm 414 is positioned forward of the user's ear, which can cause a portion of its weight to be supported over the brow of the user. By adding weight behind the user's ear (or shifting weight to behind the user's ear) in the form of earpiece 446, the ear becomes a fulcrum about which the weight of extension arm 414 is balanced against that of the earpiece 446. This can remove some of the weight on the user's nose, giving a more comfortable and a potentially more secure fit with reduced potential slipping of nosepiece 420 downward on the user's nose. The components within enlarged free end 444A, such as a battery or various control circuitry can be arranged to contribute to a desired weight distribution for device 410. For example, heavier components, such as a battery, can be placed toward or away from extension arm 414 on side arm 440A to adjust the weight distribution. In an embodiment, a majority of the weight can be carried by the ear of the user, but some weight can still be carried by the nose in order to give the device a secure feel and to keep the central portion 430 in a desired position over the brow to maintain a desired position for display 454. In an embodiment, between 55% and 90% of the weight of device assembly 410 can be carried by the user's ear.

Band 412 can be configured to resiliently deform through a sufficient range and under an appropriate amount of force to provide a secure fit on user's heads of various sizes. In an example, band 412 is configured to comfortably and securely fit on at least about 90% of adult human heads. To accomplish this, as illustrated in FIG. 9, band 412 can be structured to elastically deform (or resiliently deform) such that the distance 496 between free ends 444A and 444B can increase under force from an initial, or unflexed distance 496₁ by at least 40% and up to about 50% to a flexed distance 496₂. In other examples, distance 496₁ can increase by more than 50%. The original distance 496₁ between free ends 444A and 444B can be configured to be undersized relative to the smallest head size that band 412 is intended to be worn on such that distance 496 will increase at least somewhat (for example, by about 5%) so that the flexing of free ends 444A and 444B away from each other when worn even by users having small head sizes causes some pressure to be applied to the sides of the user's head.

Additionally, band 412 can be structured, such as by configuration thereof to a sufficient spring coefficient, such that when band 412 is expanded to fit a user of a relatively large head size, the pressure applied to the sides of the user's head by band 412 is not too great so as to cause pain while being worn or to make device 410 difficult to put on or take off. Different materials having certain characteristics can be used in different forms to give the desired flex characteristics of band 412. In one example, band 412 can have a spring coefficient for expansion, as described above, of between about 0.005 and 0.02 N/mm or, in another example, of about 1/100 N/mm. Given an exemplary spring coefficient, a band 412, as described above, can expand from an initial distance 496₁ of about 156 mm to about 216 mm by a force of between about 0.3 N and 1.2 N. In another example, such expansion can be under a force of about 0.6 N.

Band 412 can be configured to include a compliant inner portion 438 and a resilient outer portion 448. Inner portion 438 can include any portions of the band 412 that are intended to contact the user's head. In the particular embodiment shown, inner portion 438 can define the entire inner surface of band 412 to ensure that the compliant material of inner portion makes contact with the user's head regardless of the area of band 412 along which contact is made with the user's head. Inner portion 438 can be made of any material that can provide a degree of compliance to enhance the comfort of the fit of band 412 on the user's head while being able to retain its general shape. Acceptable materials include various foams, such as foam rubber, neoprene, natural or synthetic leather, and various fabrics. In an embodiment, inner portion 430 is made of an injection-molded or cast TPE. Inner portion 430 can also be made from various types of Nylon including, for example, Grilamid TR90. The compliance of the material of inner portion 430 can be measured by the durometer of the material. In an example, inner portion 438 can be made from a TPE having a durometer of between 30 and 70. Inner portion 438 can also be formed having a hollow passage therethrough or a channel formed therein opposite inner surface. Such a passage or channel can be used to route any wiring associated with extension arm 414. For example, as discussed above a battery can be housed in enlarged free end 444A of band 412 that can be connected with the internal components of extension arm 414 to provide power therefor. This connection can be made by wired routed through a channel or hollow passage through inner portion 438.

Outer portion 448 of band 412 can be made of a resiliently flexible material such as metal or plastic. In general, the nature of such a material should be such that outer portion 448 can maintain the desired shape for band 412 while allowing flexibility so that band 412 can expand to fit on a user's head while applying a comfortable pressure thereto to help retain band 412 on the user's head. Outer portion 448 can be elastically deformable up to a sufficiently high threshold that the shape of band 412 will not be permanently deformed simply by being worn by a user with a large head. Acceptable materials for outer portion 448 include metals such as aluminum, nickel, titanium (including grade 5 titanium), various steels (including spring steel, stainless steel or the like), or alloys including these and other metals. The thickness of outer portion 448 can be adjusted, depending on the material used, to give the desired flexibility characteristics. In an example, the desired fit and flexibility characteristics for band 412, discussed above, can be achieved using grade 5 titanium at a thickness of between about 0.8 mm and 1.8 mm for outer portion 448.

Inner portion 438 can have a profile such that it at least partially fits within a channel formed by outer portion 448. In an example, inner portion 438 can be sized to fit within a channel formed by a generally U-shaped cross-sectional profile of outer portion 548. Such a channel can be configured to also accept any wiring of band 412 therein or to close a partially open channel formed in inner portion 439 to hold such wiring.

As shown in FIG. 5A, side arm 440A can include an arched or curved section, such that it bends along a portion of the back of the user's ear. As with eyeglasses, the particular shape of such a bend can vary in many ways including in the size of the bend, the distance around the ear which it extends and the amount of contact, if any, actually maintained with the outside of the ear. The bend 446 in side arm 440A can blend into a continuing shape formed in the enlarged free end 444A and can be configured such that the enlarged free end 444A can be positioned in contact with a portion of the user's head behind the adjacent ear. The bend 446 can further be resiliently deformable such that different sizes and shapes of head can be accommodated by such a fit. In such an embodiment, the enlarged free end 444A can be integrally formed with inner portion 438 and can include internal support within a portion thereof that extends beyond outer portion 448. Such internal support can include an internal electronics housing that can contain batteries or electronic circuitry associated with device 410. The internal support can also include resilient members such as spring elements (not shown) to help provide flexion of band 412 and retention pressure against a wearer's head. Such spring elements can also be plastically deformable to allow for user adjustment of the position of enlarged free end 444A. Lengths of armature wire can be used to provide such characteristics. Any internal support within enlarged free end 444A can extend into the area of inner portion 438 that is within outer portion 448 to provide additional support therefor.

Extension arm 414 includes a first portion 476 that extends downward from band 412 at a first portion 476 that can be shaped to also extend along a length of band, such as along side arm 440A. First portion 476 is further shaped to extend away from band 412 to an elbow portion 450 connected with first portion 476 by a joint 456. Elbow portion 450 supports display 454 at an angle relative to arm 476 that can be adjusted by rotation of elbow portion 450 about joint 456. In the example shown in FIG. 5A, first portion 476 of extension arm 414 can be slightly curved so as to extend along a similarly curved portion of side arm 440A. Such a curve can continue on extension arm as band 412 curves inward as side arm 440A transitions to central portion 430. Extension arm 414 can be positioned vertically below band 412 such that band 412 can remain out of the user's line of sight while display 454 is visible to the user.

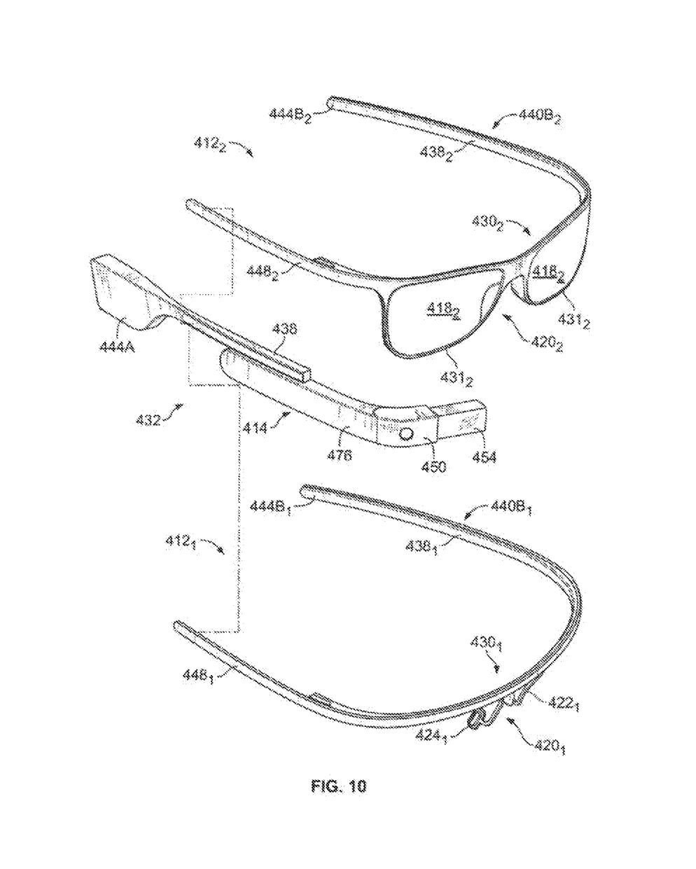

While device 410 can be configured to give a visual appearance that band 412 and extension arm 414 are distinct units, the extension arm 414 can be formed as a part of at least a portion of band 412. For example, in a band arrangement described above where band 412 includes an inner portion 438 and an outer portion 448, a portion of the extension arm housing 452 can be integrally formed with inner portion 438, as shown in FIG. 10. In such an example, internal components of extension arm 414, such as a circuit board, logic board, or the like, can extend into inner portion 438, as can an associated portion of housing 452.

In another example, the housing 452 of extension arm 414 can be connected with a housing unit internal to enlarged free end 444A, such as by an internal member. The internal member may be connected between the two such as using fixation elements, adhesive or integral forming. The housing 452, internal housing unit, and connection can then be overmolded with another material, such as TPE or the like to give a substantially uniform appearance and to form the visible portions of the inner portion 438 of band 412. Visual features, such as parting lines, relief lines, or the like can be included in the shape of such a unit 432 to give the visual appearance of separate elements, if desired.

In an embodiment where band 412 is integrally formed with or otherwise connected with generally rigid extension arm 414 along a portion thereof, band 412, while made to be flexible, may be made rigid where attached with extension arm 414. In the example shown, this may occur along a portion of side arm 440A. In such an example, it may be desired to form band 412 such that the flexation thereof, described generally above, occurs mostly within central portion 430 or in the areas of transition between central portion 430 and side arms 440A, 440B.

Such a configuration can be achieved in a number of ways. For example, side arm 440A is made more rigid by connection with rigid extension arm 414. In such an embodiment, it may be desirable to make side arm 440B rigid as well so that the side arms 440A and 440B give a more similar feel along the user's head. This can be done by assembling a structural member, such as a rigid piece of wire or the like inside of inside portion 438. Further, outside portion 448 can be structured to make side arms 440A and 440B more rigid. For example, outside portion 448 can have a U-shaped cross-sectional profile with walls that extend inward relative to outside wall. Walls can be present alongside arms 440A and 440B and can be either absent from central portion 430 or can extend inward by a lesser amount to make central portion 430 less rigid. Further, as shown in FIG. 6, band 412, including outside portion 448, can taper such that outside wall is narrower toward the middle of central portion 430. Additionally, the material thickness of outside portion 448 can be less along portions of central portion 430 of band 412 to make central portion relatively more flexible.

Display 454, which is elongated and generally defines a display axis, can extend relative to first portion 476 at an angle that can be adjusted within a range, for example, from about 100 degrees to about 125 degrees by rotation of elbow portion 450 relative to first portion 476 about joint 456. Although the shape of first portion 476 is shown in the figures as having a curved shape in the direction in which such an angle is measured, such a measurement can be taken with respect to a line tangent to any portion of first portion, such as along the end thereof toward joint 456. In another example, the adjustment angle of display 454 can be within a range of about 20 degrees, or within a range of 16 degrees or less, with the middle position of such a range positioned between about 195 degrees and 115 degrees relative to first portion 476 of extension arm 414. Joint 456 is positioned in extension arm 414 such that it can rotate along a substantially vertical axis when being worn by a user. In other words, in the embodiment shown, band 412 is formed in a U-shape that generally defines a plane. Such a plane can be considered an approximation, allowing for any curves in band 412 that are vertically displaced relative to the rest of band 412. Joint 456 can be configured such that elbow portion 450 can rotate along another substantially parallel plane or along the same plane.

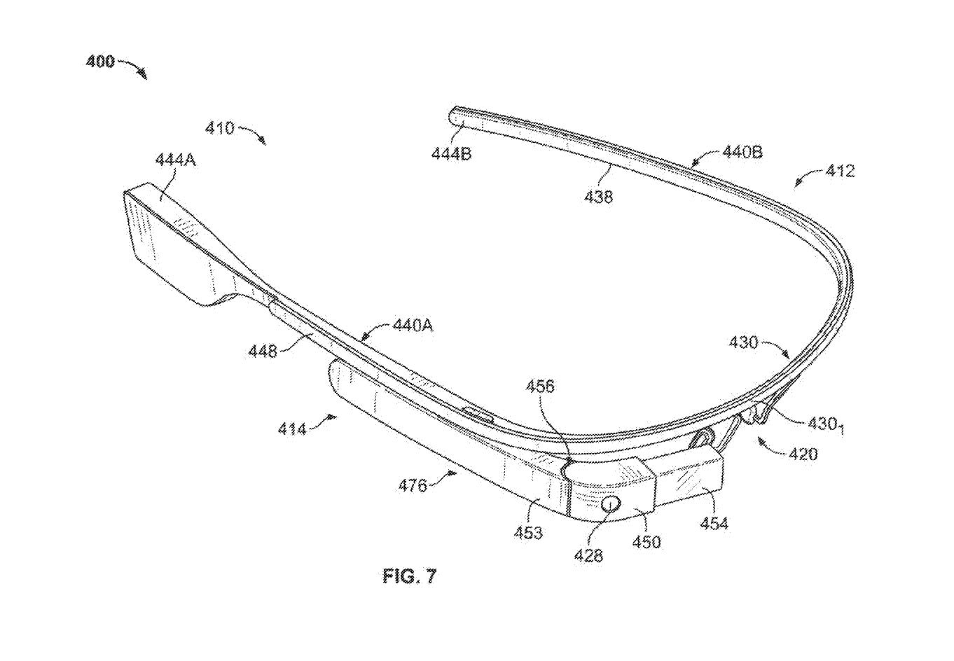

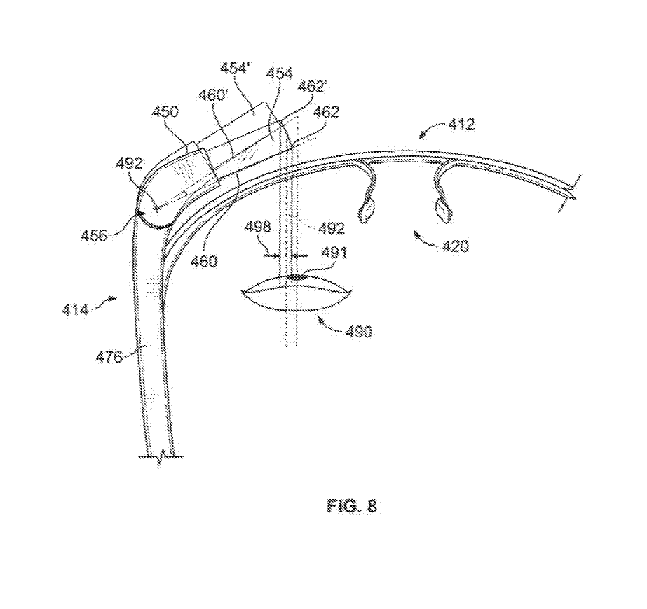

As shown in FIGS. 7 and 8, such adjustment can be used to position display 454 such that an image presented thereon can be comfortably viewed by a wearer of device 410. As shown, rotation of elbow portion 450 about axis 492 can cause surface 460 to move closer to or farther from the user's eye 490. This can allow the user to adjust the display 454 for comfortable viewing of an image presented thereon and can allow the user to position display 454 at a distance such that display 454 does not contact the user's brow or eyelashes, for example. Further, in some forms of display 454 and in certain applications, it may be desired to allow the user to adjust the lateral position of display 454 such that the inside edge 462 of surface 460 is positioned outside of the user's pupil 491 when the user's eye is in a neutral (or forward looking) position.

As shown in FIG. 8, when device 410 is being worn, display 454′ may be positioned such that it at least partially extends beyond an outside edge (indicated by line 492) of the wearer's pupil 491. The joint 456 can allow the user to rotate elbow portion 450 such that display 454, while moving outward away from eye 490, also moves along a lateral directional component by a distance 498 such that edge 462 moves to a position outside of the user's pupil when the user's eye 490 is in the neutral position shown in FIG. 8.

Additionally, the adjustment between elbow portion 450 and first portion 476 can compensate for movement of first portion 476 relative to central portion 430 or nosepiece 420 due to flexing of band 412 with which first portion 476 is joined. As shown in FIG. 9, when band 412 flexes such that distance 496 between free ends 444A and 444B increases, side arms 440A and 44B can rotate and translate relative to their positions when band 412 is unflexed. This, accordingly, causes the same rotation and translation of first portion 476 of extension arm 414. Such movement causes a corresponding rotation and translation of elbow portion 450 and display 454, depending on the shape of extension arm 414. In the example shown, display 454 is moved inward toward center 430₁ of band 412 and away from the user's eye. Other configurations of band 412 and/or extension arm 414 are possible in which display moves closer to the central portion 430, and thus closer to the user's eye.

The rotation and translation of display 454 from flexing of band 412 can cause display 454 to move into a disadvantageous position, such as too close to the user's eye or in which edge 462 is aligned with or positioned inward of the user's pupil 490, as discussed above. In such instances, elbow portion 450 can be rotated about joint 456 to counter the movement caused by the flexing of band 412 and to move display 454 into a more advantageous position.

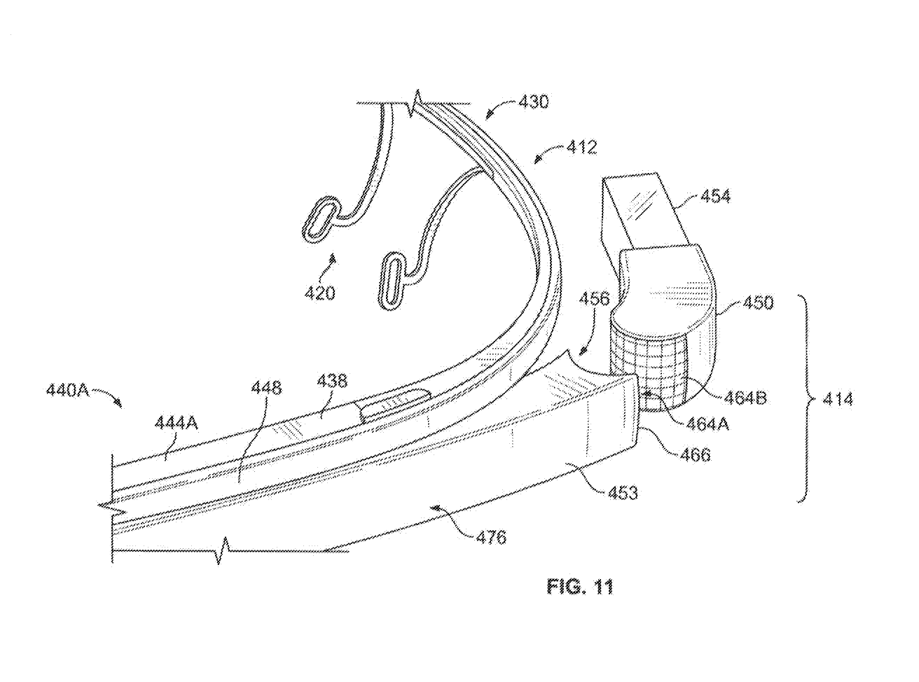

The joint 456 between first portion 476 and elbow portion 450 can include an internal hinge of sufficient friction to maintain a position in which elbow portion 450 is placed relative to first portion 476. First portion 476 and elbow portion 450 can be configured to give a uniform appearance, as shown in the figures. First portion 476 and elbow portion 450 can be further configured so that the appearance of a constant curvature of the outer surface of extension arm 414 regardless of the position of joint 456. Further, as shown in FIG. 11, an articulating surface 464A of first portion 476 can define a leading edge 466 with outer surface 453. Articulating surface 464A can be configured to intersect with outer surface such that the leading edge 466 gives the appearance of a smooth curve that has an apex thereof that overlaps elbow portion 450 more than at the outer edges thereof. Such a configuration can give a more visually pleasing and uniform appearance than if the articulating surface were a simple surface of revolution that would form a more wavy intersection with the example compound curved outer surface of extension arm 414. Articulating surface 464B is shown as transitioning from a surface that is convex along two axes adjacent surface 453 to a surface that is convex along one axis and straight along another. Articulating surface 464A can be a negative image of articulating surface 464B, which can facilitate the desired appearance of leading edge 466.

Other structures can be used to achieve lateral translational adjustment for allowing edge 462 to be positioned outside of a user's pupil 491. For example, display 454 can be mounted to first portion 476 of extension arm 414 using a sliding arrangement that can permit the desired lateral translation thereof. This can be achieved by joining second portion 450 of extension arm 414 to first portion 476 using a track or other sliding joint. An additional sliding or telescoping feature can be used to provide movement of display 454 toward and away from the user's eye to provide eye relief. In another arrangement, extension arm 414 can be a unitary structure without joint 456 and can be rotatably attached to band 412 to allow rotation in a plane similar to that of the rotation of second portion 450 shown in FIG. 8. Such rotation would, accordingly, also have a lateral component for the desired lateral adjustment of display 454 and edge 462.

In an embodiment, the image source associated with display 454 and its related circuitry can be held within elbow portion 450. Circuitry for a touch-based input 470 can be positioned within first portion 476 such that, when display 454 is positioned over a user's eye, first portion 476 is positioned in a position that extends over the user's temple adjacent that eye.

In the embodiment shown, display 454 is in the form of a generally transparent prism that is configured to overlay or combine with the user's sight an image generated by electronic display components that are positioned within the housing 452. Such a prism can be structured to receive a projected image in a receiving side and to make that image visible to a user by looking into a viewing side 460 of display 454. This can be done by configuring display 454 with a specific shape and or material characteristics. In the example shown, the receiving side of display 454 is adjacent to or within housing 452 such that the electronic components inside housing 452 can contain a video projector structured to project the desired video image into receiving side of prism 454. Such projectors can include an image source such as LCD, CRT, and OLED displays and a lens, if needed, for focusing the image on an appropriate area of prism 454. The electronic components associated with display 454 can also include control circuitry for causing the projector to generate the desired image based on a video signal received thereby. Other types of displays and image sources are discussed above and can also be incorporated into extension arm 414. Further, a display can be in the form of a video screen consisting of, for example, a transparent substrate. In such an example, the image generating means can be circuitry for a LCD display, a CRT display or the like positioned directly behind the screen such that the overall display is not transparent. The housing of the extension arm 414 can extend behind the display and the image generating means to enclose the image generating means in such an embodiment.

The receiving surface of display 454 is structured to combine the projected image with the view of the environment surrounding the wearer of the device. This allows the user to observe both the surrounding environment and the image projected into prism 454. The prism 454 and the display electronics can be configured to present an opaque or semi-transparent image, or combinations thereof, to achieve various desired image combinations.

It is also noted that, although the embodiment of FIG. 5 shows a extension arm 414 that is joined with band 412 such that it is positioned over the right eye of a user when being worn, other similar embodiments are possible in which a mirror-image of extension arm 414 can be attached on an opposite side of band 412 to make it positionable over the left eye of the user. Depending on the application of device 410 or individual user preferences, it may be desirable to position extension arm 414 on a particular side of the user's head. For example, a right-handed person may prefer having the extension arm 414 on the right side of his/her head to make interaction with touch-based input 470 easier. In another example, a person may prefer to have the display 454 over a dominant eye for easier interaction with elements presented on display 454 or over a non-dominant eye to make it easier to shift his/her focus away from elements presented on display 454 when engaged in other activities.

As discussed above, an input device in the form of a touch-based input 470 is also desirably included in extension arm 414. Touch-based input 470 can be a touchpad or trackpad-type device configured to sense at least one of a position and a movement of a finger via capacitive sensing, resistance sensing, or a surface acoustic wave process, among other possibilities. Touch-based input 470 can further be capable of sensing finger movement in a direction parallel or planar to a surface thereof, in a direction normal to the surface, or both, and may also be capable of sensing a level of pressure applied. Touch-based input 470 can be formed having an outer layer of one or more insulating, or dielectric, layers that can be opaque, translucent, or transparent, and an inner layer of one or more conducting layers that can be opaque, transparent, or translucent.

In an embodiment, the outer layer of the touch-based input 470 can be a portion of an outer wall 453 of housing 452. This can provide a seamless or uniform incorporation of touch-based input 470 into housing 452. The housing can define an interior cavity for containing the inner layer of the touch-based input 470 and any electrical structures, such as control circuitry, associated therewith. The outer layer of the touch-based input 470 can include the entire wall 453 or a selected operable area 472 in the form of one or more touch-surfaces 470 thereof, as dictated by the size, shape, and position of the inner layer of the touch-based input 470. If a portion of the housing is to be used as the outer layer of the touch-based input 470, then the housing 452 can be made of a dielectric material such as plastic. In an alternative embodiment, the touch-based input can be a discrete element that is mounted in an opening in the housing 452 that includes its own dielectric outer layer, separate from wall 453 to define the operable area within a window or opening through wall 453 in a manner similar to a touchpad on a laptop computer.

In the embodiment shown, touch-based input 470 is positioned on first portion 476 and defines a generally vertical plane that overlies a portion of the side of the user's head. Circuitry can be formed or adjusted to function with a curved outer surface, etc. Accordingly, touch-based input 470 may not be visible to a user of the assembly 410, when it is being worn.

Additionally, housing 452 can include additional input structures, such as a button 484 (shown in FIG. 5B) that can provide additional functionality for extension arm 414, including implementing a lock or sleep feature or allowing a user to toggle the power for device 410 between on and off states. The button 484 can further include an LED light beneath a surface thereof that can indicate a status of the device, such as on or off, or asleep or awake. The button can be configured such that the light is visible when on, but that the source of the light cannot be seen when the light is off.

Touch-based input 470, or another type of input, can be used to provide a control function that is executed by extension arm 414, such as by an on-board CPU or a CPU mounted to or within an associated wearable structure, or by a remote device, such as a smartphone or a laptop computer. In an embodiment, information related to the control function is viewable by the user on display 454. In one example, the control function is the selection of a menu item. In such an example, a menu with a list of options can be presented on display 454. The user can move a cursor or can scroll through highlighted options by predetermined movement of a finger along touch-based input 470 and can confirm the selection by a different movement, the acceptance of the selection being indicated by the display. Examples of menu item selections can include whether to answer or decline an incoming call on a remotely-linked smartphone or to scroll or zoom-in on a map presented in display.

Additional input structures can be included in extension arm 414. These can include a camera 428, as shown in FIG. 5A. The camera can be used to take picture or record a video at the user's discretion. The camera can also be used by the device to obtain an image of the user's view of his or her environment to use in implementing augmented reality functionality. A light sensor can be included in connection with the camera 428, for example, within the same housing feature as camera 428. Such a light sensor can be used by firmware or software associated with the camera 428. As shown in FIG. 5A, the camera (and sensor) can be included in a housing 452 positioned within the elbow portion 450 and facing in a direction substantially perpendicular to viewing surface 460 of display 454. In such an arrangement, camera 428 is positioned to face in a direction along the user's line of sight, and the sensor is positioned to sense light within the view of the camera 428.

In an embodiment, button 474 can be configured to receive an input from the user to direct device 410 to capture an image using camera 428 or one of multiple cameras of device 410. Located inside the arm 450 facing the user's eye, a second camera 426 (general location shown, but proposed location indicated by 426 in FIG. 5B) can be included to capture images of the user's eye as described above. In the alternative to a second camera, optics generating an image on display 454 may be used to capture an image of the user's eye, either periodically or before general operation (see FIG. 8, line of sight with user eye and iris ideal for image capture). In an embodiment, the control circuitry or software within device 410 can allow the user to select one or a plurality of multiple cameras with which to capture an image or “take a picture” before receiving an input using button 474 to actually capture the image using the selected camera. Button 474 can be positioned on extension arm 414 along the top surface of housing 452. Such positioning can allow for the user to grasp housing 452, for example, using the user's thumb positioned opposite from top surface with the user's index finger to press on button 474 in a pinching motion.

This action can be similar to the motion used to activate a shutter in a conventional camera (e.g., a point-and-shoot or an SLR camera) or a motion used by people to mimic such a motion, making the use of button 474 to take a picture with camera 474 more intuitive to a user. Additionally, the positioning of button 474 to be pressed in the above-described pinching motion can result in a more stable activation of button 474, wherein the user's thumb provides support for extension arm 414 when button 474 is pressed. Such stability can be further enhanced by configuring button 474 with a low activation pressure such that the force applied thereto is low enough to not cause extension arm 414 to move during image capture.

As mentioned previously, housing 452 can contain electronic circuitry such as the circuitry for touch based input 470. In addition, housing 452 can include control circuitry for the image source associated with display 454, the first camera 428, or the integrated sensor, the second camera 426, or one or more circuit boards including a processor to control display 454, touch based input 470 or to perform other functions for extension arm 414. Housing 452 can further include a power source, such as a battery to power the other circuitry. Additionally housing 452 can include memory, a microprocessor or communications devices, such as cellular, short-range wireless (e.g., Bluetooth), or WiFi circuitry for connection to a remote device. Additionally, any such circuitry can be included in band 414 such as in at least enlarged free end 444A, for example, in an internal cavity thereof.

Enlarged free end 444A can also include one or more connection contacts 482 that can be used to connect device 410 to a power source to recharge a battery without removal thereof. Further, device 410 can include a connection port 480 that can be used to connect device 410 to an external device such as a smartphone or a computer. Port 480 can be any standardized connection type port such as USB, fire-wire, thunderbolt, or a specialized port 480. Port 480 can also be configured to connect with a power source to charge a battery within device 410.

As discussed above, in an embodiment of device 410 shown in FIG. 10, extension arm 414 can be included in a unit 432 with a portion of inner portion 438 of band 412 that includes enlarged free end 444A of side arm 440A. In such an embodiment, a removable band 412₁ can include the remainder of inner portion 438₁ and the entirety of outer portion 448₁. When band 412₁ is assembled with module 432, the resulting structure can be substantially the same as discussed above with respect to FIGS. 1-9. Further, an additional band 412₂ can be provided that includes an inner portion 438₂ and an outer portion 448₂, similar to that of band 412₁. Band 412₂, however, can be structured to include a pair of rims 431₂ integrally formed therewith that can receive respective ones of a pair of lenses 418₂. The lenses 418₂ can be in the form of sunglass lenses, prescription eyeglass lenses, prescription sunglass lenses, or the like. Lenses 418₂ can be captured between portions of outer portion 448₂ and inner portion 438₂ within rims 431₂. Further, inner portion 448₂ of band 412₂ can be removable to allow the lenses 418₂ to be interchanged with band 412₂. Inner portion 438₂ can also include a nosepiece 420₂ integrally formed therewith. In this embodiment, band 412₁ and band 412₂ can be interchangeable by a user and can attach to module 432 by a snap-fit arrangement or the like. Module 432 can include a mechanism or other means to identify, for example, when a band 412₂ including sunglass lenses is assembled therewith to adjust settings of module 432, such as the brightness of display 454.

It will be understood that the circuits and other means supported by each block and combinations of blocks can be implemented by special purpose hardware, software or firmware operating on special or general-purpose data processors, or combinations thereof. It should also be noted that, in some alternative implementations, the operations noted in the blocks may occur out of the order noted in the figures. For example, two blocks shown in succession may, in fact, be executed substantially concurrently, or the blocks may sometimes be executed in the reverse order.

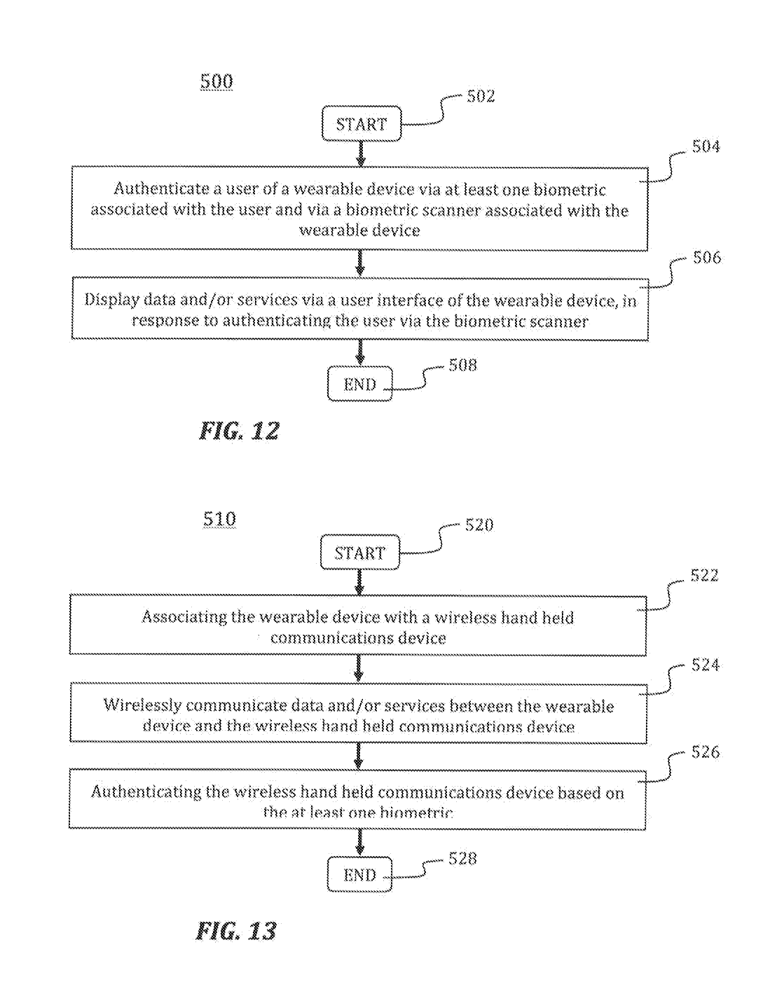

FIG. 12 illustrates a high-flow chart of operations depicting logical operational steps of a method 500 for providing data and/or services to a wearable device, in accordance with a preferred embodiment. As shown at block 502, the process can be initiated. Thereafter, as depicted at block 504, a step or logical operation can be provided for authenticating a user of a wearable device via at least one biometric associated with the user and via a biometric scanner associated with the wearable device. Then, as shown at block 506, a step or logical operation can be provided for displaying data and/or services via a user interface of the wearable device, in response to authenticating the user via the biometric scanner.

The aforementioned authenticating step shown in block 504 can further include a step or logical operation for determining the identity of the user and providing the user access to the data and/or the services based on the identity of the user. Examples of data are, for example, coupons, advertising information, video, video clips, replays, statistics, information, text, voice, etc. Examples of services are, for example, tour guides (self guided tours), providing historical information with respect to a point of interesting, providing entertainment information (e.g., voice, text, etc.) to fans at a sporting or concert event, providing medical data and patient monitoring during, for example, surgery, treatment and recovery. Other examples of services include providing assistance to drivers to prevent fatigue and auto accidents, and directional and navigational information to drivers.

Additional examples of services include providing navigational information to pedestrians or walkers, and providing activity data to athletes in motion, and soldiers in the field. Yet another example of services includes providing product, merchandise, sales and service information to customers. The process or method 500 shown in FIG. 12 can then end, as depicted as block 508. Although not shown in FIG. 12, an optional step or logical operation can be implemented in which a user profile is initially established with respect to the user and the at least one biometric for use in authenticating the user and establishing an access level with respect to the user for access to the data and/or the services. An additional and optional step or logical operation can also be provided for invoking via the user interface of the wearable device, a user interactivity with respect to the data and/or the services via the wearable device.

The biometric scanner can be integrated with an optical and image-processing system associated with the wearable device and/or can be implemented as an “app” that enables the wearable device to perform biometric scanning (recognition) operations. The wearable device can be implemented as head gear worn by a user. Examples of such head gear include, for example, eyeglasses or a hardware system configured in the form of virtual reality gaming goggles worn by the user.

In another embodiment, the aforementioned at least one biometric may be, for example, a retinal scan gathered through optics integrated with the wearable device. In yet another embodiment, the at least one biometric can include at least one other biometric gathered through the wearable device. The wearable device may be implemented as data enabled eyewear. Additionally, in some embodiments, the aforementioned authenticating step shown in block 504 can be facilitated by a remote server (e.g., a server or group of servers). The data and/or the services accessed based on the identity of the user can be retrieved from such a remote server.

FIG. 13 illustrates a high-flow chart of operations depicting logical operational steps of a method 510 for providing data and/or services to a wearable device, in accordance an alternative embodiment. As shown at block 520, the process can be initiated. Thereafter, as depicted at block 522, a step or logical operation can be implemented for associating the wearable device with a wireless hand held communications device. Then, as shown at block 524, a step or logical operation can be implemented for wirelessly communicating data and/or services between the wearable device and the wireless hand held communications device. Next as shown at block 526, a step or logical operation can be implemented for authenticating the wireless hand held communications device based on the at least one biometric. The process can then terminate, as shown at block 528.

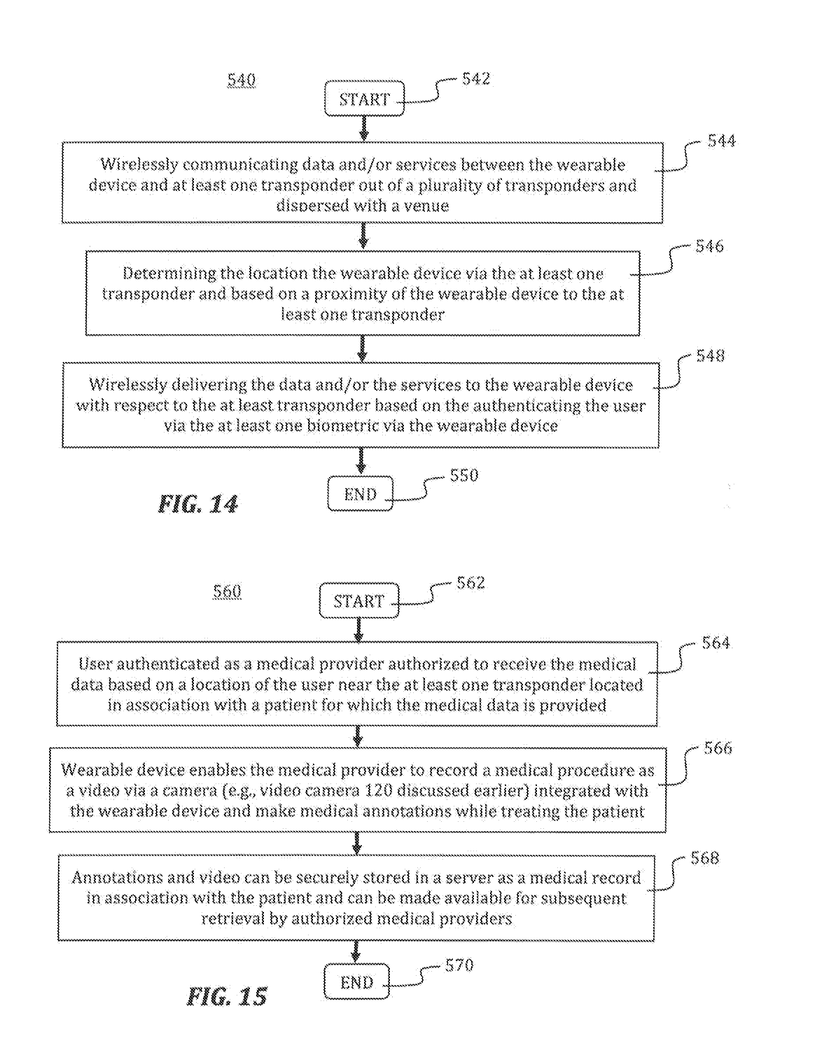

FIG. 14 illustrates a high-flow chart of operations depicting logical operational steps of a method 540 for providing data and/or services to a wearable device, in accordance an alternative embodiment. As shown at block 542, the process can be initiated. Next, as depicted at block 544, a step or logical operation can be provided for wirelessly communicating data and/or services between the wearable device and at least one transponder out of a plurality of transponders and dispersed with a venue. The at least one transponder is preferably within range of, for example, a Bluetooth (i.e., Bluetooth standard) range or a WiFi range of communication with respect to the wearable device.

One example of a transponder that can be implemented in accordance with one or more embodiments is the “iBeacon.” iBeacon is the trademark for the proximity system that Apple Inc. has referred to as “a new class of low-powered, low-cost transmitters that can notify nearby iOS devices of their presence.” The technology enables an iOS device or other hardware to send push notifications to iOS devices in close proximity. Devices running the Android operating system, for example, can receive iBeacon advertisements but cannot emit iBeacon advertisements (i.e., central role only).

The iBeacon works on Bluetooth Low Energy (BLE), also known as Bluetooth Smart. BLE can also be found on Bluetooth 4.0 devices that support dual mode. iBeacon uses Bluetooth low energy Proximity sensing to transmit a universally unique identifier capable of being picked up by a compatible app or operating system that can be turned into a physical location or trigger an action on the device.

Note that a “venue” can be, for example, sports venue (e.g., a stadium, arena, etc.) and/or an entertainment venue (e.g., concert hall, etc.). The user in such a scenario may be, for example, a spectator or fan at the sports venue and/or the entertainment venue. Other examples of a “venue” include, for example, a shopping mall or shopping center, a casino, and a convention center.

Thereafter, as depicted at block 546, a step or logical operation can be provided for determining the location of the wearable device via the at least one transponder and based on a proximity of the wearable device to the at least one transponder. Next, as shown at block 548, a step or logical operation can be provided for wirelessly delivering the data and/or the services to the wearable device with respect to the at least transponder based on the authenticating the user via the at least one biometric via the wearable device. The process can then terminate, as shown at block 550.

Note that in some embodiments, the aforementioned data and/or services may comprise, for example, advertising information (e.g., advertisements, coupons, offers, etc.). In another embodiment, the such data and/or services can include, for example, statistics (e.g., sports statistics such as baseball statistics). In yet another embodiment, such data can be, for example, historical information associated with a tour (e.g., a self-guided tour in a museum). In another embodiment, such data can be, for example, medical data, as discussed in more detail below with respect to FIG. 15.

FIG. 15 illustrates a high-flow chart of operations depicting logical operational steps of a method 560 for providing data and/or services to a wearable device, in accordance an alternative embodiment. As shown at block 562, the process can be initiated. Thereafter, as depicted at block 564, the user can be authenticated as a medical provider authorized to receive the medical data based on a location of the user near the at least one transponder located in association with a patient for which the medical data is provided. Thereafter, as depicted at block 566, the wearable device enables the medical provider to record a medical procedure as a video via a camera (e.g., video cameras 120, 228, 428 discussed earlier) integrated with the wearable device and make medical annotations while treating the patient.

Note that in a preferred embodiment, such annotations can be voice annotations recorded by the wearable device. As shown next at block 568, the annotations and the video can be securely stored in a server as a medical record in association with the patient and can be made available for subsequent retrieval by authorized medical providers. The process can thereafter terminate, as shown at block 570.

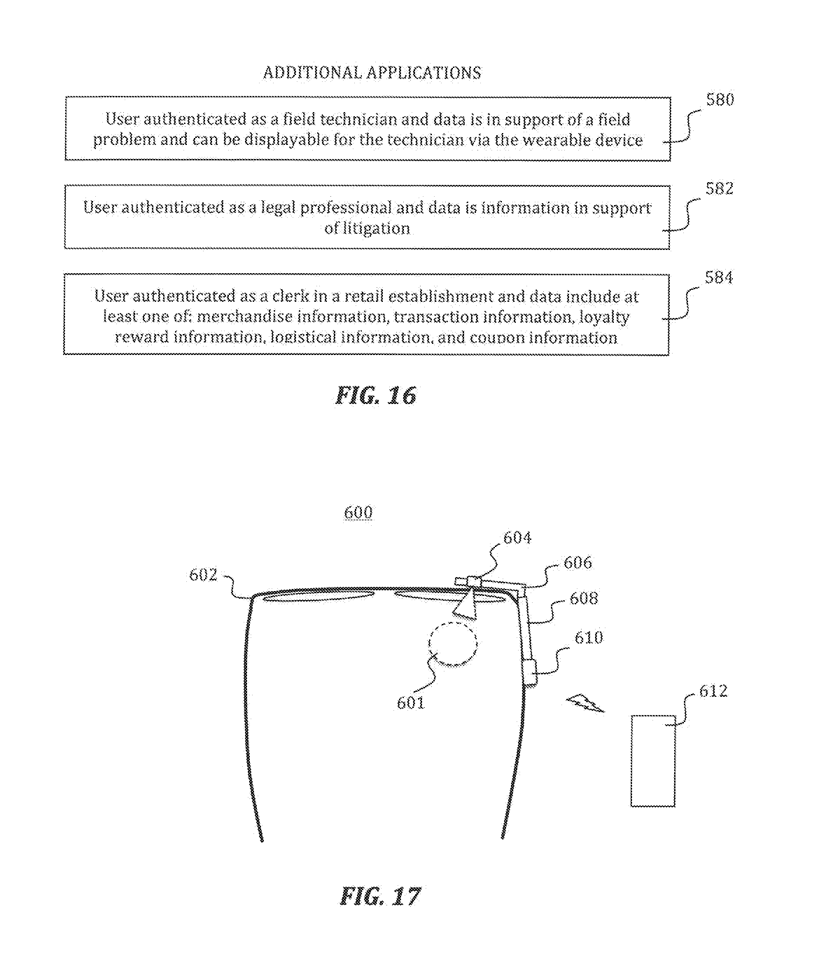

FIG. 16 illustrates a block diagram depicting other potential user applications for wearable devices, in accordance with alternative embodiments. As shown at block 580, in a field technician application, the user can be authenticated as a field technician and the data may be data in support of a field problem and can be displayable for the technician via the wearable device. In another embodiment, as shown at block 582, the user can be authenticated as a legal professional and the data can be, for example, information in support of litigation. In yet another embodiment, as shown at block 584, the user can be authenticated as a clerk in a retail establishment and the data can include at least one of, for example: merchandise information, transaction information, loyalty reward information, logistical information, and coupon information.

FIG. 17 illustrates a block diagram of a system 600 for providing data and/or services to wearable devices, in accordance with an alternative embodiment. System 600 can include, for example, hardware such as a wearable device 602 which is associated with a biometric scanner 604. In system 600, the user of the wearable device can be authenticated via at least one biometric 601 (i.e., iris) associated with the user and via the biometric scanner 604 (e.g., second camera 121, 207, 229, 426 as described earlier) associated with the wearable device 602. Data and/or services are displayable via a display 606 associated with the wearable device 602 in response to authenticating the user via the biometric scanner 604 and can be controlled by a user interface 608 also associated with the wearable device 602. In another embodiment, authentication of the user via the biometric scanner 604 can involve determining the identity of the user and providing the user access to the data and/or the services based on the identity of the user. In some embodiments, authentication of the user can be facilitated by a remote server 612 that communicates wirelessly (e.g., via a wireless network) using a wireless module 610 associated with the wearable device 602. The data and/or the services accessed based on the identity of the user can be retrieved from such a remote server 612. Note that in some embodiments, the biometric scanner 604 can be integrated with an optical and image-processing system associated with the wearable device 602. Note that a user profile with respect to the user and the at least one biometric for use can be established for use in the authenticating the user. Additionally, an access level can be established with respect to the user for access to the data and/or the services.

In some embodiments, the biometric scanner 604 can be a retinal scanner. In another embodiment, the biometric scanner 604 can be an iris recognition scanner. In yet another embodiment, the biometric scanner 604 can be a voice recognition scanner. In still another embodiment, biometric scanner 604 can be a fingerprint recognition device. In another embodiment, the biometric scanner 604 can be an ear acoustical scanner for biometric identification using acoustic properties of an ear canal.

The wearable device 602 can be, for example, head gear such as, eyeglasses or a hardware system configured in a form of virtual reality gaming goggles worn by the user. The at least one biometric 601 can include at least one other biometric gathered through the wearable device.

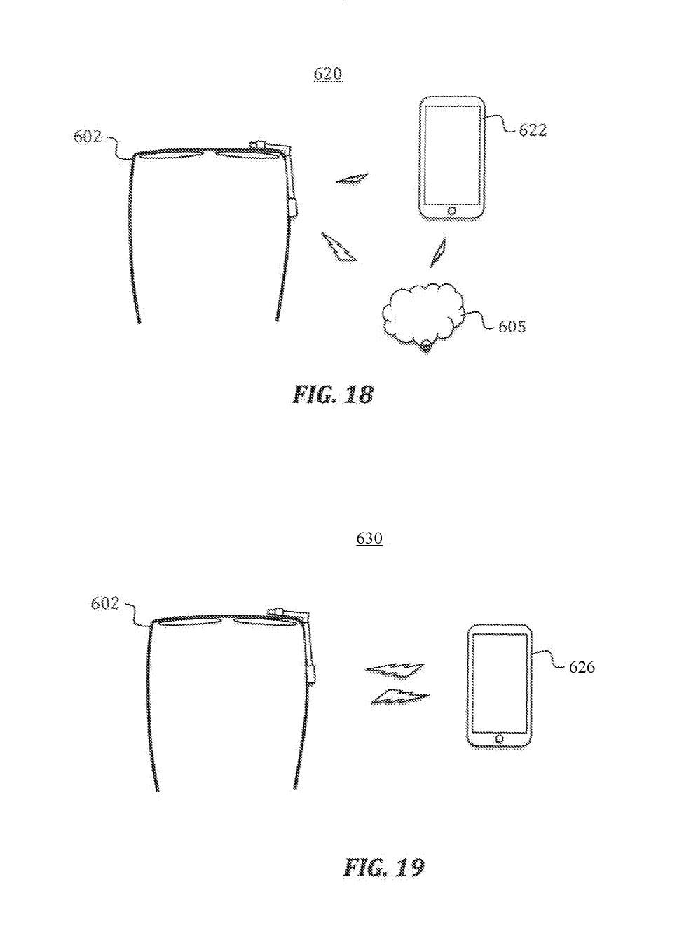

FIG. 18 illustrates a block diagram of a system 620 for providing data and/or services to wearable device 602, in accordance with an alternative embodiment. In system 620, the wearable device 602 can be associated with a wireless hand held communications device 622. The data and/or the services discussed previously can be wirelessly communicated between the wearable device 602 and the wireless hand held communications device 622. The wireless hand held communications device 622 can be authenticated based on the at least one biometric 601, as discussed earlier. The wearable device 602 can be configured with a wireless communications module 610 that enables cellular voice and data communication for the wearable device 602, either directly with wireless data networks 605, or via the wireless hand held communications device 622.

FIG. 19 illustrates a block diagram of a system 630 for providing data and/or services to wearable device 602, in accordance with an alternative embodiment. In system 630, the wearable device 602 is capable of bidirectional communication with a second screen 626 in order to provide a larger viewing platform of the data and/or the services. In system 630, the second screen 626 can be a display screen located within viewing proximity of the wearable device 602. Such a second screen 626 can be, for example, a device such as a display screen of a smartphone, a laptop computer, a tablet computing device, a flat panel television, a display screen integrated in an automotive dashboard, a projector, or a display screen integrated into an airliner seat.

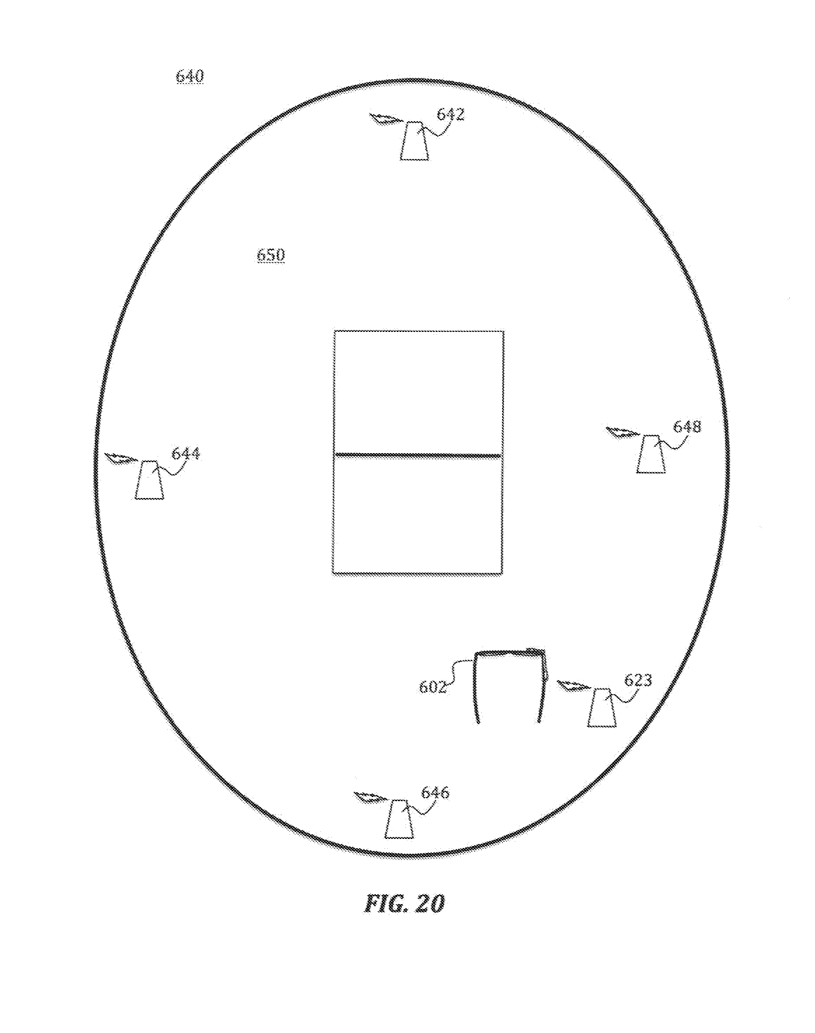

FIG. 20 illustrates a block diagram of a system 640 for providing data and/or services to a wearable device 602 that can communicate with a plurality of transponders 642, 644, 646, and 648, in accordance with an alternative embodiment. System 640 generally includes the plurality of transponders 642, 644, 646, and 648. The data and/or the services are capable of being wirelessly communicated between the wearable device 602 and at least one transponder 623 out of the plurality of transponders 642, 644, 646, and 648, and dispersed with a venue 650. At least one transponder 623, for example, may be within, for example, a Bluetooth range or a WiFi range of communication with the wearable device 602. Venue 650 may be, for example, a venue such as a sports stadium, sports arena, a concert arena, an entertainment venue, etc., wherein the user is a fan, spectator, concert goer, etc.

In system 640, the location of the wearable device 602 can be determined via, for example, the at least one transponder 642 and based on the proximity of the wearable device 602 to the at least one transponder 642. The data and/or the services are capable of being wirelessly delivered to the wearable device 602 with respect to the at least transponder 642 based on authenticating the user via the at least one biometric 601 via the wearable device. Such data may be, as indicated earlier, advertising information (e.g., coupons, advertisements, sales information, merchandise information, etc.), statistics, historical information associated with a tour, etc.

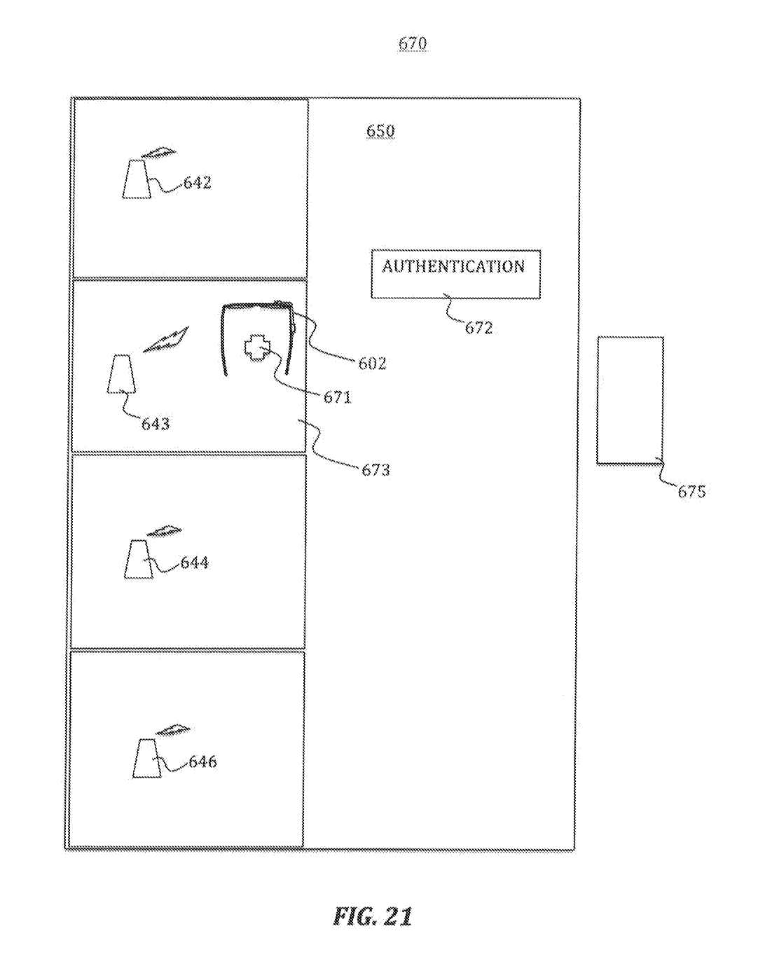

FIG. 21 illustrates a block diagram of a system 670 for providing data and/or services to a wearable device 602 in accordance with an alternative embodiment. In system 670, the data and/or the services may be, for example, respectively, medical data and/or services. Block 672 of system 670 comprises a module for authenticating the user as a medical provider 671 authorized to receive the medical data based on a location of the user near at least one transponder 643 located in association with a patient for which the medical data is provided. The patient and transponder can be located in a room 673 within a venue 650. In system 670, it can be assumed that the venue 650 is a hospital, medical facility, medical clinic, etc. The wearable device 602 enables the medical provider to obtain treatment checklists, obtain treatment guidance, record a medical procedure as video via a camera (e.g., video camera 120) integrated with the wearable device 602 and make medical annotations while treating the patient. As indicated previously, such annotations can be, for example, voice annotations recorded by the wearable device 602. The annotations and the video can be securely stored in a server 675 (e.g., a remote server) as a medical record in association with the patient and made available for subsequent retrieval by authorized medical providers. Checklists and health guidance can also be obtained from the server 675.

Note that in other embodiments, the user can be authenticated as a field technician and the data comprises data in support of a field problem and is displayable for the technician via the wearable device 602, as a legal professional and the data comprises legal information in support of litigation, or as a clerk in a retail establishment and the data comprises merchandise information.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for providing data and/or services to wearable devices, said method comprising:
authenticating a user of a wearable device via at least one biometric associated with said user and via a biometric scanner associated with said wearable device; and
displaying data and/or providing services via a user interface of said wearable device, in response to authenticating said user via said biometric scanner.
